(19) United States
(12) Patent Application Publication
(10) Pub. No.: US 2021/0025525 A1
(43) Pub. Date: Jan. 28, 2021

(54) HAMMER UNION ASSEMBLY

(71) Applicant: BEST FLOW LINE EQUIPMENT, L.P., Houston, TX (US)

(72) Inventors: Martin FRITZ, Houston, TX (US); Jason NELMS, Houston, TX (US); Curtis THIERRY, Houston, TX (US)

(21) Appl. No.: 16/523,633

(22) Filed: Jul. 26, 2019

(51) Int. Cl. F16L 19/02

(52) U.S. Cl. CPC F16L 19/02

(57) ABSTRACT

A hammer union assembly has a male union, a female union having external threads adjacent at the end thereof, a wingnut having internal threads therein in which the external threads of the female union are engaged with internal threads of the wingnut, and a sleeve interposed between the wingnut and the male union. The male union has an end facing the end of the female union. The wingnut has four lugs extending outwardly of a body thereof. The internal threads of the wingnut have a non-full root radius. The internal threads have a flat at a major diameter thereof and a pair of flanks extending inwardly from opposite sides of the flat.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

### 1. Field of the Invention

The present invention relates to hammer unions. More particularly, the present invention relates to the configuration of the threads of such hammer unions. Additionally, the present invention relates to hammer unions having a plurality of lugs extending outwardly therefrom.

### 2. Description of Related Art Including Information Disclosed Under 37 CFR 1.97 and 37 CFR 1.98

In the testing and production of hydrocarbon wells, specialized couplings are provided which incorporate seals to prevent leakage between the coupling components. One such coupling is known as a union and comprises a coarse male thread on one of the components which cooperates with coarse female threads on the collar to provide a quick connect/disconnect coupling.

A more specialized quick connect/disconnect coupling is known as a hammer union which comprises four components: a thread end having coarse male threads on the exterior thereof, a seal on the inside of the thread end, a nut end having a smooth nose abutting the seal, and a hammer nut having coarse female threads on the interior and lugs on the exterior which may be struck with a hammer to cinch up the coupling. Because hammer unions have the capability of being quickly connected and disconnected, they are widely used in temporary installations or in equipment which is expected to be disassembled periodically.

Hammer unions have not been redesigned in many decades. The seal in a conventional hammer union is a large annular rubber seal that is basically rectangular in cross-section. One of the coupling components provides a groove receiving the annular rubber seal which is compressed between the coupling components when they are cinched up, thereby providing a seal. The rubber component is exposed to gases, fluids and abrasives flowing in the interior flow passage of the coupling. This conventional seal has withstood the test of time and has basically been unchanged for at least 50 years.

In the past various patents and patent application publications have issued with respect to such hammer unions. An early hammer union patent is that of U.S. Pat. No. 2,417,025, issued on Mar. 4, 1947 to A. S. Bolpin. This patent teaches a hammer union for pipe connections having a member on each pipe end, a ring rotatable on one member, interfitting tapered portions on the other member, and a ring to draw the two members together upon rotation of the ring relative to the member on which it is mounted. There is a tapered locking piece carried by the ring to tangentially engage the other one of the members so as to be hammered into locking position.

U.S. Pat. No. 6,764,109, issued on Jul. 20, 2004 to Richardson et al., describes a hammer union and seal. The hammer union has a thread end, a nut end and a hammer nut which, when cinched up, compresses a composite seal assembly so as to prevent leakage. The seal assembly has a metal insert of a size to pass into the seal groove of conventional hammer unions and a small seal acting between the insert, the thread and the nut end. The small seal is an O-ring and is of a size that is compressed when the seal assembly is inserted into the thread end of the hammer union.

U.S. Pat. No. 6,945,569, issued on Sep. 20, 2005 to Diaz et al., provides a union for connecting two tubular members. The first tubular member has an external flange. The second tubular member has a set of external threads. An annular nut surrounds the first tubular member. The nut has an internal flange that surrounds the first tubular member, and a set of threads to engage the threads of the second tubular member. Arcuate segments are circumferentially mated between the internal flange of the nut and the external flange of the first tubular member. A flat conical surface on the inner side of the segment comes into contact with a flat conical surface on the other side of the external flange. Curved conical surfaces tangentially align with and extend from the flat conical surfaces on the segment and the external flange. Cylindrical surfaces tangentially align and join the curved conical surfaces on the segment and the tubular member.

U.S. Pat. No. 8,118,528, issued on Feb. 21, 2012 to L. Herndon, describes a field replaceable hammer union wingnut. This wingnut has an arcuate body and an arcuate insert. The wingnut is designed to replace an existing wingnut which has deformed or non-usable lugs on a hammer union connection. The wingnut has arcuate alignment of the mounting threads using an alignment attachment device.

U.S. Pat. No. 8,408,605, issued on Apr. 2, 2013 to J. P. Curtiss, shows a hammer union lock. The threaded union includes a threaded union nut configured to couple abutting ends of a threaded nipple on a distal end of a first joint and a shouldered nipple on a distal end of a second joint. There is a lower wedge and an upper wedge positioned within an offset distance formed between a lower surface of the union nut and an upper surface of an enlarged section of the shouldered nipple.

U.S. Patent Application Publication No. 2011/0175349, published on Jul. 21, 2011 to Dallas et al., provides a high-pressure threaded union with a metal-to-metal seal. This metal ring gasket provides a high-pressure temperature tolerant metal-to-metal seal between subcomponents of a threaded union. The metal ring gasket is received in an annular cavity formed between mating surfaces of the subcomponents of the threaded union.

U.S. Patent Application Publication No. 2016/0377207, published on Dec. 29, 2016 to Witkowski et al., is shown and described in FIGS. 1-3 herein. In particular, this patent application publication describes a “full-root-radius” threaded wingnut having increased wall thickness. As shown in FIG. 1, this patent application publication describes a wingnut 10 having has a body 12 having an axial length between a first end surface 14 and a second end surface 16. The body 12 also has an exterior surface 18 extending between the first end surface 14 and the second end surface 16. The wingnut 10 includes an interior passage 20 axially extending through the body 12 from the first end surface 14 to the second end surface 16. The passage 20 defines an interior surface 22 of the body 12. An internal shoulder is formed in the body 12 and defines a portion of the passage 20. The wingnut can also has an internal threaded connection formed by the interior surface 22 that extends from the first end surface 14 toward the internal shoulder. The wingnut 10 also include circumferentially-spaced lugs 24, 26 and 28. These lugs 24, 26 and 28 extend radially outwardly from the exterior surface 18 of the body 12.

FIG. 2 is a cross-sectional view showing the various components of the wingnut assembly 30 of U.S. Patent Application Publication No. 2016/0377207. The hammer union 30 includes a male union 32, a threaded female union 34, wingnut 10 (as shown in FIG. 1), a seal ring 36, a plurality of retainer segments 38, and a retaining ring 40. Generally, the female union 34 is concentrically disposed about the seal ring 36 with the seal ring 36 engaging both the female union 34 and the male union 32. Opposing faces of the female union 34 and the male union 32 are engaged and the plurality of retainer segments 38, which are held together using the retainer ring 33, are concentrically disposed about the male union 32. The wingnut 10 is concentrically disposed about each of the male union 32, the plurality of retainer segments 38, the seal ring 36, and the female union 34 so as to couple the mail union 32 to the female union 34. The wingnut 10 is shown as having internal threads 42. The female union 34 has an external threads 44 engaged with the female threads 42. Importantly, in U.S. Patent Application Publication No. 2016/0377207, it is required that the internal threads 42 are full root radius threads. This is particularly shown in FIG. 3 herein.

FIG. 3 is an illustration from U.S. Patent Application Publication No. 2016/0377207 regarding these “full root radius” threads. In particular, when the wingnut 10 is a three inch wingnut, the internal threaded connection 46 has a full-root radius, as indicated as the radius R on in FIG. 3. The internal threaded connection 46 may have a full-root radius of 0.06 inches or 0.07 inches. The internal threaded connection 46 has an National Acme Thread Form and thus a pitch angle, as indicated as the angle in FIG. 3 of 29°. The internal threaded connection 46 has a National Acme Thread Form and thus a pitch angle of 29° and has a full-root radius of 0.053 inches. It was intended that this internal threaded connection 46 having the full-root radius reduces the amount of stress experienced in the body of the wingnut 10 near the internal threaded connection 46.

Conventional hammer unions have wing nuts with three lugs. Whenever three plug configurations are used on the wingnut, there are times when it is difficult to attain a proper orientation for the hammering process. In order to remove the wingnut or to install the wingnut, it is necessary for a person views a sledgehammer and strike one of the lugs of the wingnut. Under certain circumstances, after being struck with the sledgehammer, the lugs will be an awkward position. As such, the person to use a sledgehammer will have to move around in order to attain a proper hammering angle with respect to the lug. It has been found that come over time, the use of three lugs on the wingnut creates stress concentrations across the wingnut. As one can imagine, when one of the lugs of the wingnut is struck, this strong sledgehammer-type force creates stresses across the body of the wingnut and, in particular, those areas directly opposite the struck lug. It is found that after continual use, the wingnut will start to have a deformed triangular configuration. Whenever the wingnut is substantially deformed, it must be repaired or replaced. Three lugs have also been conventionally used because of weight considerations.

Furthermore, with respect to the teachings of U.S. Patent Application Publication No. 2016/0377207, the use of the “full root radius” is a rather undesirable threaded connection. Because of the need to create a “full root radius”, the depth of the thread is increased. In particular, at the very root of the “full-root radius”, there is a point of concentration and stress between the external thread in the internal thread. This small area of contact at the major diameter of the “full root radius” increases stress concentrations within the wingnut after repeated blows with a sledgehammer. The use of full root radius threads creates load concentrations onto the body of the wingnut that are undesirable. As such, this would reduce the effective life of the wingnut and, in particular, the threads of the wingnut.

It is an object of the present invention to provide a hammer union of assembly that reduces areas of load concentrations and stress points throughout the body of the wingnut.

It is another object of the present invention to provide a hammer union assembly that presents a greater number of lug surfaces to the operator.

It is still another object of the present invention provide a hammer union assembly which avoids the deformation of the wingnut after repeated use.

It is still another object of the present invention to provide a hammer union assembly which dissipates shock stress around the body of the wingnut.

It is still further object of the present invention to provide a hammer union assembly which reduces effort by the sledgehammer user and reduces the amount of movement by the user during the connection or disconnection of the hammer union assembly.

These and other objects and advantages of the present invention will become apparent from a reading of the attached specification and appended claims.

### BRIEF SUMMARY OF THE INVENTION

The present invention is a hammer union assembly that comprises a male union, a female union having external threads adjacent to an end thereof, a wingnut having internal threads therein which are engaged with the external threads of the female union, and a sleeve interposed between the wingnut and the male union. The wingnut has more than three lugs extending outwardly of the body thereof. The internal threads of the wingnut have a non-full root radius.

The internal threads of the wingnut have a flat at a major diameter thereof and a pair of flanks extending inwardly from opposite sides of the flat. The flat is planar around the major diameter. Each of the pair of flanks has a radius.

The wingnut has four lugs evenly circumferentially spaced from each other around the wingnut. The sleeve is a split sleeve. In particular, the split sleeve has an exterior shoulder bearing against the internal shoulder of the wingnut. The split sleeve extends over and outer diameter of the male union. The male union has an external shoulder adjacent the end of the male union. The split seat sleeve has an end bearing against the external shoulder of the male union. There is at least one seal ring interposed between the end of the male union and the end of the female union.

The wingnut has a body from which the four lugs extend. A blend radius is formed between the body and each of the lugs. The body is a first end and a second end. Each of the lugs has a side positioned axially inwardly from at least one of the first and second ends of the body.

This foregoing Section is intended to describe, with particularity, the preferred embodiments of the present invention. It is understood that modifications to these preferred embodiments can be made within the scope of the present claims. As such, this Section should not to be construed, in any way, as limiting of the broad scope of the present invention. The present invention should only be limited by the following claims and their legal equivalents.

### BRIEF DESCRIPTION OF THE SEVERAL VIEWS OF THE DRAWINGS

FIG. 1 is a perspective view of a prior art wingnut as used in a hammer union assembly.

FIG. 2 is a cross-sectional side view of a hammer union assembly of the prior art.

FIG. 3 is a detailed cross-sectional view showing threads of the prior art with a full-root radius.

FIG. 4 is a perspective view of the hammer union assembly of the present invention.

FIG. 5 is a cross-sectional view of the hammer union assembly in accordance with the teachings of the present invention.

FIG. 6 is a cross-sectional view showing the wingnut of the hammer union assembly of the present invention.

FIG. 7 is an enlarged view of the circled area of FIG. 6 showing, in particular, the non-full-root radius threads as used in the wingnut of the hammer union assembly of the present invention.

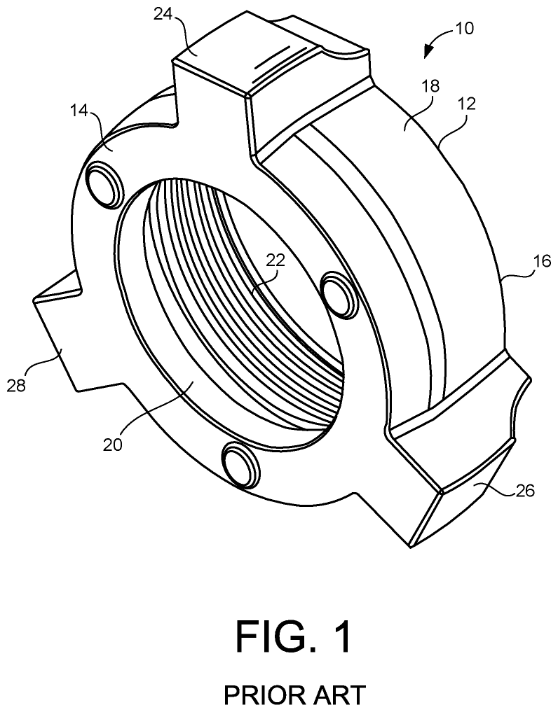

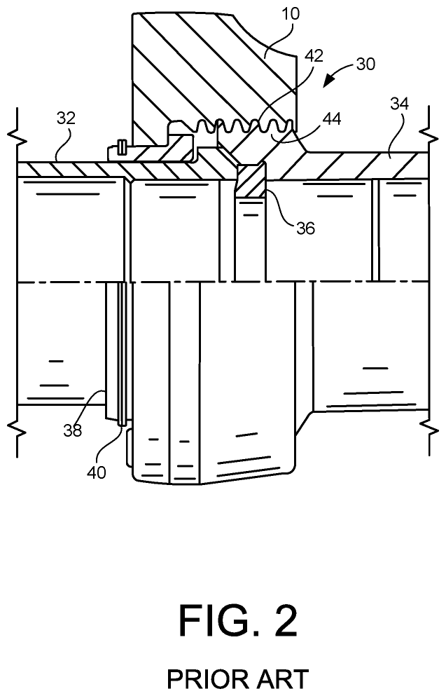

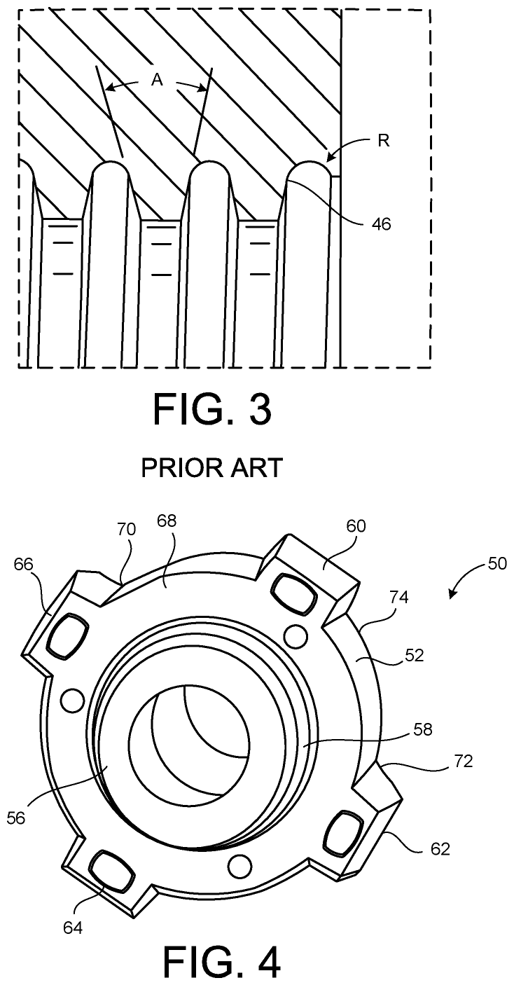

### DETAILED DESCRIPTION OF THE INVENTION

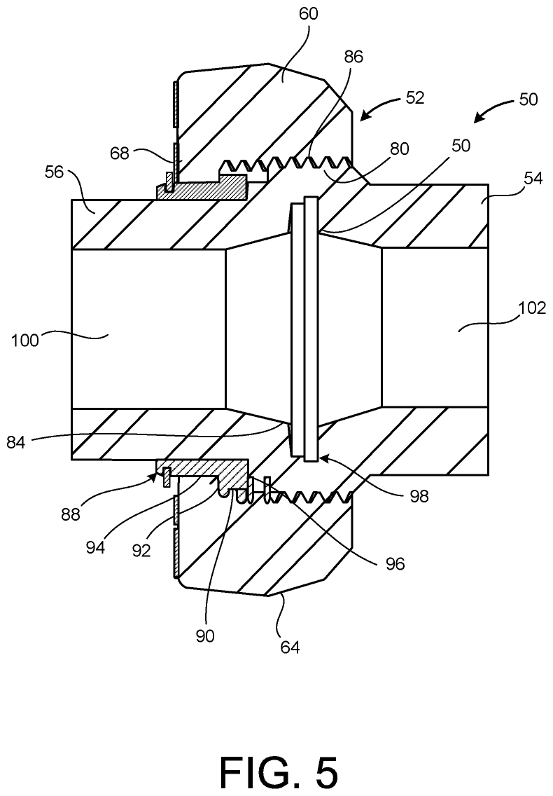

Referring to FIG. 4, there is shown the hammer union assembly 50 in accordance with teachings of the present invention. The hammer union assembly 50 includes a wingnut 52, a female union 54 and a male union 56. The female union 54 and the male union 56 are arranged in generally end-to-end relationship within the interior 58 of the wingnut 52. The configuration of the interior 58 of the wingnut 52 is shown in greater detail hereinafter in FIG. 5.

The wingnut 52 has four lugs 60, 62, 64 and 66. In particular, lug 60 is diametrically opposite to lug 64. Lug 62 is diametrically opposite to lug 66. This configuration of four lugs has been found to dissipates shock stress around the body 68 of the wingnut 62. Since lug 68 is diametrically opposite to lug 62, when lug 62 is struck with the sledgehammer, the greater thickness of the body 68 caused by the configuration of the diametrically-opposite lug 66 will prevent or reduce shock concentrations directly opposite to the lug 62. As such, unlike previous three lug configurations, the use of the four lugs in which the lugs are diametrically opposite to each other prevents or reduces the triangulation of the body 68 of the wingnut 52 over continual use. The use of the four wingnuts 60, 62, 64 and 66 presents a striking surface to the person with the sledgehammer in a more convenient location than the use of three lugs. In other words, after one of the lugs is struck with a sledgehammer, another of the lugs will be in a more convenient location for striking when the body 68 of the wingnut 52 is rotated about the male union 56 and the female union 54.

In FIG. 4, it can be seen that there is a blend radius 70 that is formed to between the body 68 and the lug 66 and another blend radius 72 illustrated as formed between the body 68 and the lug 62. This blend radius causes the respective lugs to be positioned inwardly slightly from the opposite end 74 of the body 68. Once again, this blend radius tends to dissipates shock stress around the body. Under those circumstances where there is no blend radius between the lugs and the body, a great deal of force is at the ends of the body 68, in particular at the location of each of the lugs. Over time, the lack of a blend radius has been found to cause deformation of the wingnut 52.

FIG. 5 shows the hammer union assembly 50 of the present invention in cross-section. In particular, FIG. 5 shows the male union 56, the female union 54, and the wingnut 52. The female union 54 has threads 80 adjacent to an end 82 thereof. The male union 56 has an end 84 facing the end 82 of the female union 54. The wingnut 52 has internal threads 86 therein. The external threads 80 of the female union 54 are engaged with the internal threads 86 of the wingnut 52. The wingnut 52 has lugs 60 and 64 extending outwardly of body 68. The internal threads 86 have a non-full root radius. A sleeve 88 is interposed between the wingnut 52 and the male union 56.

The sleeve 88 is a split sleeve. The split sleeve allows for easy installation over the male union 56. The split sleeve 88 has an external shoulder 90 bearing against an internal shoulder 92 of the wingnut 52. The split ring 88 extends over an outer diameter of the male union 56. The split sleeve 88 also is interposed between an inner surface 94 of the wingnut 52 and the outer diameter of the male union 56. The split sleeve 88 provides a seal between the wingnut 52 and the male union 56. The male union has an external shoulder 96 adjacent to the end 84 of the male union 56. The split sleeve 88 has an end bearing against this external shoulder 96 of the male union 56.

There is at least one seal ring 98 interposed between the end 84 of the male union 56 and the end 82 of the female union 54.

In normal use, and as used in conventional hammer union assemblies, when the lugs 60 and 64 are struck with a sledgehammer, the rotation of the wingnut 52 will compress the split sleeve 88 so as to create requisite seals between the surfaces of the male union 56 and the wingnut 52. The threaded connections between the wingnut 52 and the female union 56 will cause the female union 54 to move relative to the male union 56 and compress the seal ring 82 so as to establish a liquid-tight seal between the interior passage 100 of the male union 56 and the internal passage 102 of the female union 54.

FIG. 8 shows a cross-sectional view of the wingnut 52. In particular, it can be seen that the wingnut 52 has lug 60 at the top thereof and lug 64 at the bottom thereof. The blend radius 104 is illustrated as extending between the lugs 60 and the end 106 of the wingnut 52. As such, the lug 60 will actually be positioned inwardly of the end 106 of the wingnut 52. Similarly, the blend radius 108 will cause the lug 64 to be positioned inwardly of the end 106 of the wingnut 52. As stated herein previously, the blend radiuses 104 and 108 serve to dissipate shock stress around the body 68 of the wingnut 52. In particular, it avoids those stress points directly at the end 106 of the wingnut 52.

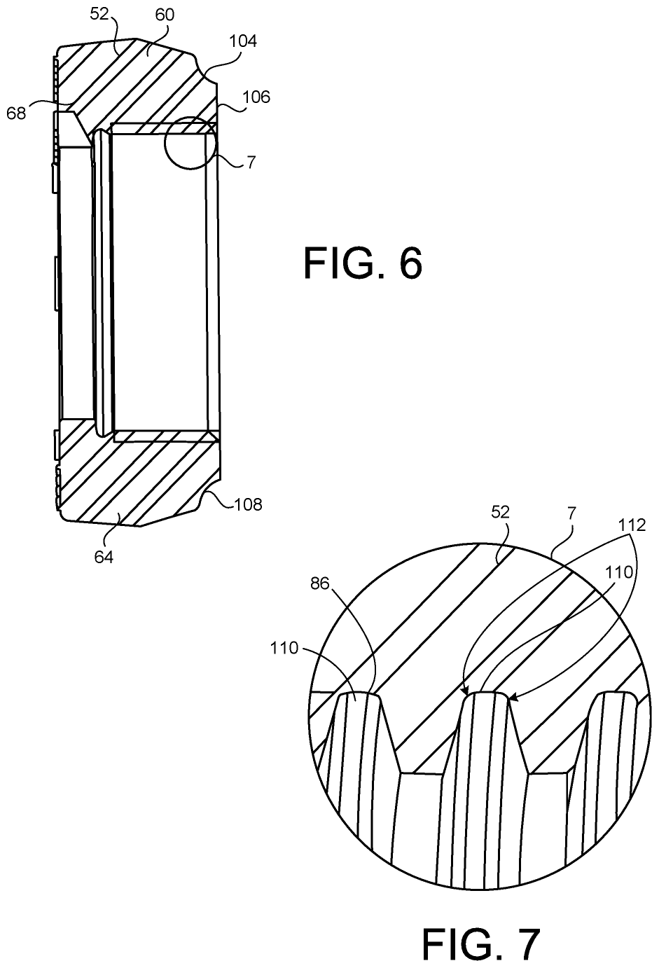

FIG. 6 show a circled area 7. Circled area 7 is illustrated in greater detail in FIG. 7. FIG. 7 shows the internal configuration of the internal threads 86 of the wingnut 52. Importantly, it can be seen that the internal thread 56 does not have a full-root radius. In fact, the internal thread 86 has a flat 110 that the major diameter of the thread 86 and a pair of flanks 112 extending inwardly from opposite sides of the flat 110. In particular, in the preferred embodiment the present invention, the flat has a width of less than 0.05 inches. The flat is planar around the major diameter of the thread. Each of the pair of flanks is curved so as to have a radius. In the preferred embodiment of the present invention, this radius will be approximately 0.03 inches.

This particular configuration of thread superior to the full-root radius thread. By having a flat 110 and a pair of flanks 112, the height of the external threads that mate with these internal threads 86 can be reduced. Furthermore, the major diameter can also be reduced. The major diameter of the thread is the area where the point concentration of stresses will occur. In a full-root radius thread, there will be a point of maximum concentration of stress forces. The present invention avoids this concentration of forces by providing a flat area of contact rather than a point area of contact. The radiused flanks also serve to distribute shock forces more evenly around the body of the wingnut and also around the female union 54. This configuration is also important where a four-lugged wingnut is used. Since the force from a strike of a sledgehammer onto one of the four lugs is somewhat absorbed by the opposite lug, the unique configuration of the non-full root thread of the present invention further distributes load concentrations. The stress points between the threads and the four lugs is changed in the present invention. In the present invention, the stress concentration would be generally at the two corners of the root rather than a single localized location in the major diameter of the root. When forces are placed into the major diameter of the root, the thread can crack. The present invention, by providing these two points of contact will further reduce the possibility of cracking as a result of the forces applied. As such, by the combination of the non-full root thread and the four lugs, the life of the hammer union assembly can be increased and the deformation of the wingnut of the hammer union assembly minimized.

The foregoing disclosure and description of the invention is illustrative and explanatory thereof. Various changes in the details of the illustrated construction can be made within the scope of the appended claims without departing from the true spirit of the invention. The present invention should only be limited by the following claims and their legal equivalents.

I claim:

1. A hammer union assembly comprising:
a male union;
a female union having external threads adjacent an end thereof, said male union having an end facing the end of said female union;
a wingnut having an internal threads therein, the external threads of said female union engaged with the internal threads of said wingnut, said wingnut having more than three lugs extending outwardly therefrom, the internal threads of said wingnut having a non-full root radius; and
a sleeve interposed between said wingnut and said male union.

2. The hammer union assembly of claim 1, the internal threads of said wingnut having a flat at a major diameter thereof and a pair of flanks extending inwardly from opposite sides of the flat.

3. The hammer union assembly of claim 2, the flat being entirely planar around the major diameter, each of the pair of flanks having a radius.

4. The hammer union assembly of claim 1, said more than three lugs comprising four lugs evenly circumferentially spaced from each other around said wingnut.

5. The hammer union assembly of claim 1, said sleeve being a split sleeve.

6. The hammer union assembly of claim 5, said split sleeve having an external shoulder bearing against an internal shoulder of said wingnut, said split sleeve extending over an outer diameter of said male union.

7. The hammer union assembly of claim 6, said male union having an external shoulder adjacent the end of said male union, said split sleeve having an end bearing against said external shoulder of said male union.

8. The hammer union assembly of claim 1, further comprising:
at least one seal ring interposed between the end of said male union and the end of said female union.

9. The hammer union assembly of claim 1, said wingnut having a body from which the lugs extend, a blend radius being formed between said body and each of the lugs.

10. The hammer union assembly of claim 9, said body having a first end and a second end, each of the lugs having a side positioned axially inwardly from at least one of the first and second ends of said body.

11. A hammer union assembly comprising:
a male union;
a female union having external threads adjacent an end thereof, said male union having an end facing the end of the female union;
a wingnut having internal threads therein, the external threads of said female union being engaged with the internal threads of said wingnut, the internal threads of said wingnut having a non-full root radius; and
a sleeve interposed between said wingnut and said male union.

12. The hammer union assembly of claim 11, said wingnut having four lugs extending outwardly therefrom.

13. The hammer union assembly of claim 11, the internal threads of said wingnut having a flat at a major diameter thereof and a pair of flanks extending inwardly from opposite sides of the flat.

14. The hammer union assembly of claim 13, the flat being planar around the major diameter, each of the pair of flanks having a radius.

15. The hammer union assembly of claim 11, said wingnut having a body with a first end and a second end, said wingnut having four lugs extending outwardly of said body, each of the four lugs having a side positioned axially inwardly from at least one of the ends of said body.

16. A hammer union assembly comprising:
a male union;
a female union having external threads adjacent an end thereof, said male union having an end facing the end of said female union; and
a wingnut having internal threads therein, the external threads of said female union engaged with the internal threads of said wingnut, said wingnut having four lugs extending outwardly of a body of said wingnut, said body having a first end and a second end, each of the four lugs having a side positioned axially inwardly from at least one of the first and second ends of said body.

17. The hammer union assembly of claim 16, wherein the internal threads of said wingnut have a non-full root radius.

18. The hammer union assembly of claim 17, the internal thread of said wingnut having a flat at a major diameter thereof and a pair of flanks extending inwardly from opposite sides of the flat.

19. The hammer union assembly of claim 18, the flat being planar around the major diameter, each of the pair of flanks having a radius.

20. The hammer union assembly of claim 17, said wingnut having a blend radius formed between said body and each of the four lugs.
